(19) United States
(12) Patent Application Publication
(10) Pub. No.: US 2020/0055540 A1
(43) Pub. Date: Feb. 20, 2020

(54) Fixed Bearing, Steering Gear, and Steering System

(71) Applicant: Robert Bosch GmbH, Stuttgart (DE)

(72) Inventors: Jens-Uwe Hafermalz, Waeschenbeuren (DE); Dennis Fuechsel, Schwaebisch Gmünd (DE)

(21) Appl. No.: 16/607,779

(22) PCT Filed: Apr. 26, 2018
(86) PCT No.: PCT/EP2018/060756

§ 371 Date: Oct. 24, 2019

(30) Foreign Application Priority Data
May 8, 2017 (DE) 10 2017 207 708.5

(51) Int. Cl. B62D 5/04; F16C 27/06; F16C 25/06; F16C 35/067

(52) U.S. Cl. CPC B62D 5/0409; F16C 27/066; F16C 2380/27; F16C 35/067; F16C 2326/24; F16C 25/06

(57) ABSTRACT

A fixed bearing for a steering gear includes a rotational bearing that has an inner bearing ring configured to receive a pinion shaft of the steering gear and an outer bearing ring that is received in a bearing sleeve. The fixed bearing also includes a pivot ring that has an outer ring and an inner ring that are pivotally connected via one or more torsion webs. The inner ring is connected to the bearing sleeve. The outer ring is disposed in a housing of the steering gear and configured to support the fixed bearing. The inner ring and the outer bearing ring are clamped between an axial stop of the bearing sleeve and a clamping ring. Such clamping reduces backlash and prevents undesired noises due to motion of these elements within the bearing sleeve during the operation of the steering gear with the fixed bearing.

The invention relates to a fixed bearing for a steering gear. The invention furthermore relates to a steering gear having such a fixed bearing as well as to a steering system having such a steering gear for a motor vehicle. The steering system can in particular be a power-assisted steering system.

Power-assisted steering systems which generate a supporting torque when steering and on account thereof reduce the steering moment to be applied by the driver to a steering column of the motor vehicle are installed in most motor vehicles.

The known power-assisted steering systems are based on a steering gear which transforms the drive output of a hydraulic or electric steering motor and transmits said drive output to the steering column, for example. Steering gears of this type are typically configured in the form of a helical rolling gear and in particular as a helical wheel gear or worm gear. Said gears comprise a gear wheel which is connected directly or indirectly to the steering column, as well as a pinion which meshes with said gear wheel and by way of a shaft is driven by the steering motor.

Gear play which is configured by virtue of component tolerance, dissimilar thermal expansion of the gear elements, by virtue of wear, and/or by virtue of material settling in the case of gear wheels from plastics material has proven problematic in the case of steering gears of this type. In particular in the case of so-called alternating steering, that is to say in the case of steering with alternating steering angle direction in direct succession, such gear play generates undesirable noises which result in particular from opposite flanks of the teeth of the pinion and the gear wheel bearing on one another in an alternating manner.

It is known for said gear play to be eliminated on account of the pinion shaft being mounted so as to be pivotable about an axis running perpendicular to the longitudinal axis of the pinion shaft and at a spacing from the toothing engagement of pinion and gear wheel, and being pressed against the gear wheel by means of one or more spring elements. Here, the pivoting capability of the pinion shaft is integrated into one of the two bearing arrangements by which the pinion shaft is mounted at the ends. Said bearing arrangement is also referred to as “fixed bearing”. The bearing arrangement in the region of the other end is then implemented with a defined play (so-called “floating bearing”) in order to permit the deflection caused by the pivoting movement. The fixed bearing is generally provided at the drive side, whereas the floating bearing is provided on the free end of the pinion shaft. The one or more spring elements for pressing the pinion against the gear wheel herein can be integrated into the floating bearing and the fixed bearing.

Such a steering gear in which the spring force for the spring loading is generated by means of the fixed bearing is known, for example from DE 10 2009 054 655 A1. In the case of this steering gear it is provided that the roller bearing which receives the pinion shaft in the region of the fixed bearing is mounted within a pivot sleeve. The pivot sleeve comprises a bearing sleeve which receives the roller bearing in a largely play-free manner, and an outer ring which is held in a largely play-free manner in a receptacle of a housing of the steering gear, wherein the outer ring and the bearing sleeve are connected by way of a plurality of torsion webs which are torsioned when the outer ring is twisted in relation to the bearing sleeve.

After the assembly of the steering gear the torsion webs are torsioned in such a manner that the elastic restoring effect generated on account thereof causes the spring loading of the pinion shaft.

Design embodiments of steering gears which are similar to that of DE 10 2009 054 655 A1 are known from DE 10 2008 040 673 A1, EP 2 836 416 B1, and EP 2 836 417 B1.

An unintended noise behavior, in particular following an extensive service life of the steering gears, can also arise in the case of the steering gears known from the publications mentioned.

The invention is based on the object of improving a steering gear as is known in principle from DE 10 2009 054 655 A1, DE 10 2008 040 673 A1, EP 2 836 416 B1, and EP 2 836 417 B1 in terms of the noise behavior mentioned.

This object is achieved by a fixed bearing as claimed in patent claim 1. A method for producing such a fixed bearing, a steering gear having such a fixed bearing, and a steering system having such a steering gear are the subject matter of patent claims 7 to 10. Advantageous design embodiments of the fixed bearing according to the invention and thus of the steering gear according to the invention and of the steering system according to the invention as well as preferred embodiments of the method according to the invention are the subject matter of the dependent patent claims and/or are derived from the description of the invention hereunder.

A fixed bearing according to the invention for a steering gear comprises a rotary bearing, in particular a roller bearing and preferably a ball bearing, which has an inner bearing ring, which is provided for receiving a pinion shaft of the steering gear, and an outer bearing ring, which is received in a bearing sleeve. The fixed bearing furthermore comprises a pivot ring, which has an outer ring as well as an inner ring, said rings being pivotably connected by way of one or a plurality of torsion webs, wherein the inner ring is connected (indirectly) to the bearing sleeve and the outer ring is provided for mounting the fixed bearing in a housing of the steering gear. Such a fixed bearing is characterized according to the invention in that the inner ring and the outer bearing ring of the rotary bearing are disposed so as to be braced (directly or indirectly) between an axial detent of the bearing sleeve and a tension ring, that is to say are disposed so as to be impinged by a defined pretensioning force. The pretensioning force herein can preferably be at least 10 kN, particularly preferably at least 15 kN, and approx. 18 kN, for example.

On account of the bracing of the inner ring of the pivot ring and of the outer bearing ring of the rotary bearing between the axial detent of the bearing sleeve and the tension ring, play between these elements received within the bearing sleeve can be eliminated, on account of which it can be prevented that unintended noises are created on account of a mobility of said elements within the bearing sleeve in the operation of a steering gear according to the invention that comprises such a fixed bearing.

In order to guarantee that any unintended generation of noise is prevented during the entire envisaged service life of the fixed bearing, despite wear, on account of the preferably one-off bracing which in particular takes place in the context of a production of the fixed bearing and thereafter is unchangedly maintained, it should preferably be provided that the elements of the fixed bearing, or portions of said elements, that are impinged by the bracing are configured in such a manner that a relevant elastic deformation is achieved as a result of the impingement by the defined pretensioning force such that a wear-related readjustment and consequently a permanent absence of play in the braced elements can be achieved on account of a restoring effect caused by said elastic deformation.

To this end, it can preferably be provided that the axial detent is configured by a radially inwardly pointing end portion of the bearing sleeve, said end portion having been configured by forming. Such an axial detent of the bearing sleeve, while simultaneously being simple to produce, can be distinguished by an advantageous or a relatively highly developed, respectively, deformation behavior as a result of the impingement by the pretensioning force and consequently act as an elastic restoring element which can advantageously guarantee a readjustment of the braced elements as a result of wear. As a result of a design embodiment of the axial detent as a primarily utilized elastic restoring element, it can advantageously be achieved that the remaining braced elements and thus (optionally inter alia) the inner ring of the pivot ring and the outer bearing ring of the rotary bearing can be configured so as to be relatively stiff or rigid, respectively, which can have a positive effect in terms of the structural design embodiment of said elements and/or in terms of any functionality (conjointly) caused by said elements. The latter can be relevant in particular to the outer bearing ring of the rotary bearing, in particular in the case of the design embodiment thereof as a roller bearing/ball bearing, because a significant deformation of a bearing ring of such a rotary bearing could lead to a significant increase in the frictional resistance in the relative movement between the two bearing rings.

Accordingly, a utilization of the axial detent as an elastic restoring element can have a particularly advantageous effect when, as is in principle preferred, exclusively the inner ring and the outer bearing ring of the rotary bearing, and consequently no further element, are disposed so as to be braced between the axial detent of the bearing sleeve and the tension ring. One advantage of such a design embodiment of the fixed bearing according to the invention lies inter alia in a particularly compact shape of the fixed bearing.

However, there is alternatively also the possibility for one or a plurality of further elements to be disposed between the axial detent of the bearing sleeve and the tension ring which preferably can be configured as an annular tension disc. One or a plurality of said further elements can in particular also be primarily provided for acting as an elastic restoring element which as a result of the bracing is thus to be elastically deformed in a targeted manner to a relevant degree.

According to one preferred design embodiment of a fixed bearing according to the invention it can be provided that the tension ring is disposed within the bearing sleeve. A relatively compact design embodiment of the fixed bearing can result on account thereof, on the one hand. The production of a fixed bearing according to the invention can furthermore be simplified on account thereof, because a positioning or centering, respectively, of the tension ring can take place in a self-acting manner on account of the disposal of the tension ring within the bearing sleeve.

It can preferably be provided that the fixed bearing after the production is configured so as to be finally braced and thus no possibility for being able to vary the bracing subsequently and in particular after an extensive service life of the fixed bearing, or of a steering gear comprising the fixed bearing, respectively, is provided (such a subsequent variability however also being implementable in principle). On account thereof, the fixed bearing according to the invention can be designed so as to be simple in terms of construction and consequently be produced in a cost-effective manner.

Permanently ensuring the bracing in the context of the production can preferably be achieved in that the tension ring in the context of the production is impinged by the defined pretensioning force on account of which the elements disposed between said tension ring and the axial detent are pushed against the axial detent, and the tension ring, still maintaining said pretensioning force, is fixed in relation to the bearing sleeve and is in particularly connected directly to the bearing sleeve. This can preferably be implemented in a materially integral manner and in particular by welding, preferably by means of laser welding, which represents a cost-effective potential in terms of production. However, there is alternatively also the possibility for the tension ring to be fixed in a form-fitting and/or force-fitting manner in relation to the bearing sleeve and to be connected in particularly directly to the bearing sleeve. For example, it can be provided that the tension ring is provided with an external thread which can be screwed into an internal thread of the bearing sleeve so that the bracing of the elements provided to this end by the defined pretensioning force (as a result of an elastic restoring effect) is achieved by screwing the tension ring into the bearing sleeve to a greater or lesser degree.

In order for the pretensioning force that has been applied to the tension ring in the context of the production of a fixed bearing according to the invention to be able to be advantageously supported, it can preferably be provided that the bearing ring externally configures at least one supporting protrusion. This supporting protrusion can preferably extend across the entire circumference of the bearing sleeve, or at least the largest part thereof, so as to prevent any tilting of the bearing sleeve as a result of the support. It can particularly preferably be provided that the supporting protrusion is disposed close to the same axial end of the bearing sleeve on which the tension ring is also provided, on account of which an advantageous deformation behavior can be achieved for that portion of the bearing sleeve that extends from the supporting protrusion to the corresponding other axial end of the bearing sleeve.

In the case of a method according to the invention for producing a fixed bearing according to the invention it is provided that the rotary bearing and the inner ring of the pivot ring are positioned within the bearing sleeve, wherein said rotary bearing and said inner ring of the pivot ring are disposed between the axial detent of the bearing sleeve and the tension ring, and a defined pretensioning force which is supported by the bearing sleeve as well as the tension ring is subsequently generated, on account of which the inner ring of the pivot ring and the outer bearing ring of the rotary bearing is braced between the axial detent of the bearing sleeve and the tension ring.

A steering gear according to the invention for a steering system of a motor vehicle comprises, apart from a fixed bearing according to the invention, at least one gear wheel, a helical pinion meshing with the latter, and a pinion shaft comprising the helical pinion, wherein the pinion shaft on the one side of the helical pinion is mounted in the fixed bearing according to the invention, and wherein the outer ring of the pivot ring of the fixed bearing is disposed so as to be established directly or indirectly in a housing of the steering gear.

A steering system according to the invention comprises at least one steering gear according to the invention as well as a steering motor that in a rotatably driving manner is connected to the pinion shaft. The gear wheel of the steering gear can furthermore be connected in a rotationally fixed or a rotatably driving manner to a steering shaft, in particular a steering column, of the steering system. The steering system according to the invention can in particular be configured as a power-assisted steering system by way of which a supporting torque can be generated by means of the steering motor such that a steering moment that is to be applied to the steering column by a driver of a motor vehicle comprising the power-assisted steering system for steering the motor vehicle is reduced (optionally temporarily also down to zero). Alternatively thereto, there is also the possibility for the steering system to be configured in such a manner that the entire steering moment required for steering is generated (at all times) by the steering motor.

The invention furthermore relates to a motor vehicle having a steering system according to the invention.

The indefinite articles (“a”, “an”, “of a” and “of an”), in particular in the patent claims and in the description that generally discusses the patent claims, are to be understood as such and not as numerals. Components discussed in concrete terms using these are thus to be understood as being present at least singly, and as being capable of being present in a multiplicity.

The invention will be discussed in more detail below on the basis of an exemplary embodiment illustrated in the drawings. In the drawings:

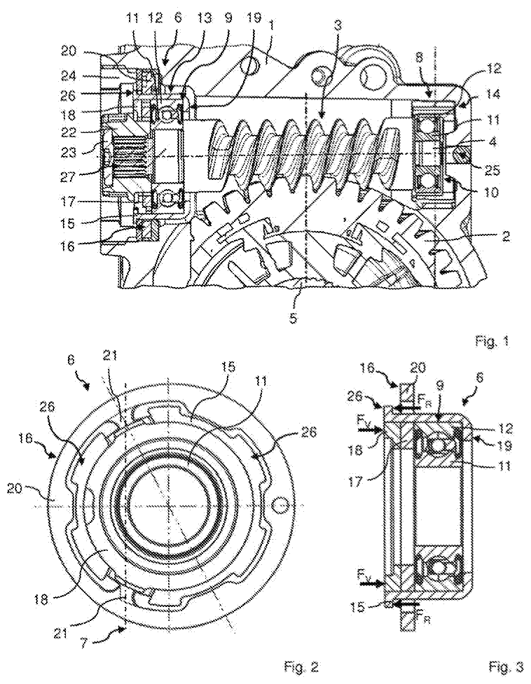

FIG. 1 shows a longitudinal section through a steering gear according to the invention;

FIG. 2 shows the fixed bearing of the steering gear according to FIG. 1 in a view from the front; and

FIG. 3 shows a longitudinal section through the fixed bearing according to FIG. 2.

FIG. 1 shows the substantial component parts of a steering gear of a steering system according to the invention. Said steering gear comprises a housing 1, a gear wheel 2 as well as a helical pinion 3 that meshes with the gear wheel 2 being rotatably disposed within said housing 1. The helical pinion 3 and a (helical) pinion shaft 4 comprising the helical pinion 3 are integrally configured in the form of a worm.

The gear wheel 2 is fixedly fastened on an output shaft 5 of the steering gear. Said output shaft 5 which in the exemplary design embodiment shown has a toothing for connecting in a rotatably fixed manner to the gear wheel 2 can mesh with a steering rod which at least in one portion is configured as a rack, for example, on account of which the rack carries out a translatory movement which in a manner known by way of a wheel control arm (not illustrated) can be converted to a pivoting movement of steering-capable wheels (not illustrated) of the motor vehicle. However, the output shaft 5 can also be a steering column of a power-assisted steering system, said steering column being connected to a steering wheel and acting on the rack by way of a steering pinion.

The helical pinion shaft 4 has a drive-side end by way of which said helical pinion shaft 4 is connectable to the output shaft (not illustrated) of a steering motor (for example an electric motor). The helical pinion shaft 4 by means of a first mounting is mounted in the housing 1 in the region of said drive-side end. Said mounting is configured as a fixed bearing 6 which permits pivoting of the helical pinion shaft 4 about a pivot axis 7 (cf. FIG. 2). This pivoting causes a deflection of the end of the helical pinion shaft 4 that is opposite the drive-side end, said helical pinion shaft 4 there being mounted in a corresponding receptacle of the housing 1 by means of a floating bearing 8. Said floating bearing 8 is configured such that said floating bearing 8 within limits permits the deflection of this end of the helical pinion shaft 4 resulting from the pivoting of the helical pinion shaft 4.

Both the fixed bearing 6 as well as the floating bearing 8 comprise in each case one rotary bearing 9, 10 in the form of a ball bearing. One portion of the helical pinion shaft 4 is in each case mounted in inner bearing rings 11 of said rotary bearings 9, 10, while outer bearing rings 12 of the rotary bearings 9, 10 are in each case mounted in one bearing device 13, 14 which in turn are received in associated receptacles of the housing 1. The bearing devices 13, 14 in terms of construction are configured such that said bearing devices 13, 14, in the case of the fixed bearing 6, enable the pivoting of the helical pinion shaft 4 about the pivot axis 7, or in the case of the floating bearing 8, enable the deflection of the free end of the helical pinion shaft 4.

To this end, the bearing device 13 of the fixed bearing 6 comprises a bearing sleeve 15 having a circular cross-section, which internally in a first longitudinal portion receives the outer bearing ring 12 of the rotary bearing 9 and in a second longitudinal portion receives an inner ring 17 of a pivot ring 16. The inner ring 17 of the pivot ring 16, inter alia on account of the effect of a disc-shaped tension ring 18, is mounted so as to be rotationally fixed and axially secured within the bearing sleeve 15, wherein the inner ring 17 is supported on the outer bearing ring 12 of the rotary bearing 9. Specifically, the inner ring 17 of the pivot ring 16, stressed on one side by the tension ring 18, is pushed against one side of the outer bearing ring 12 of the rotary bearing 9 which in turn on the other side thereof is supported on an axial detent 19 which is formed by an inwardly bent and, on account thereof, radially aligned, end portion of the bearing sleeve 15.

Apart from the inner ring 17, the pivot ring 16 also comprises an outer ring 20. The outer ring 20 is connected to the inner ring 17 by way of two torsion webs 21 (cf. FIG. 2). The outer ring 20, the inner ring 17, and the torsion webs 21 are preferably configured integrally, for example from spring steel.

Axial positional securing of the rotary bearing 9 on the helical pinion shaft 4 takes place by interposing a coupling piece 22 by means of a screw 23 which is screwed into an internal thread which is integrated into the drive-side end of the helical pinion shaft 4. The coupling piece 22 also serves for transmitting a drive output of the steering motor to the helical pinion shaft 4, to which end said coupling piece 22 and said helical pinion shaft 4 are connected to one another in a rotationally fixed manner. This rotationally fixed connection is achieved on account of an external toothing 27 of the helical pinion shaft 4 engaging in a complementary internal toothing of the coupling piece 22.

Axial positional securing of the outer ring 20 of the pivot ring 16 within the housing 1 takes place by means of a screw ring 24 which has an external thread which is screwed into a complementary internal thread of the housing 1.

The two torsion webs 21 define the position of the pivot axis 7 about which the outer ring 20 is pivotable relative to the inner ring 17. The torsion webs 21 and thus the pivot axis 7 herein do not run through the center of the pivot ring 16 and thus also not through the center of the cross section of the helical pinion shaft 4, but so as to be radially offset thereto (cf. FIG. 2). The pivot axis 7 thus does not intersect the longitudinal axis 25 of the helical pinion shaft 4. On account of the radial offset of the torsion webs 21 to the center of the pivot ring 16, the pivot axis 7 is repositioned close to the external circumference of the helical pinion shaft 4 on account of which a configuration of reaction moments which result, or would result, respectively, as a consequence of the toothing forces resulting from the toothed engagement of the helical pinion 3 and the gear wheel 2, in conjunction with the spacing of the effective line of said toothing forces from the pivot axis 7 can be minimized or avoided. In order for said reaction moments to ideally be completely avoided, it is provided that the pivot axis 7 lies within that tangential plane which is configured in the point of contact of the two pitch circles, or rolling pitch circles, respectively, of the gear wheel 2 and the helical pinion 3.

The torsion webs 21 of the pivot ring 16 not only enable pivoting of the outer ring 20 in relation to the inner ring 17 and thus of the helical pinion shaft 4 relative to the gear wheel 2 or to the housing 1, respectively, but at the same time cause that spring force by way of which the helical pinion 3 of the helical pinion shaft 4 is pushed into the toothing of the gear wheel 2, so as to achieve an ideally minor gear play and thus a minor generation of noise in the operation of the steering gear, in particular in case of so-called alternating steering. This spring force from the helical pinion shaft 4 in the assembly of the steering gear as a result of contact with the gear wheel 2 being deflected so far that sufficient torsioning of the torsion webs 21 results, on account of which the elastic restoring moments which result from the torsioning of the torsion webs 21 act counter to said deflection of the helical pinion shaft 4 and thus impinge the latter against the gear wheel 2.

In order for an unintended generation of noise as a result of a relative movement of the elements (inner ring 17 of the pivot ring 16 and outer bearing ring 12 of the rotary bearing 9) that are received within the bearing sleeve 15 to be avoided in the operation of the steering gear and in particular also over the entire envisaged service life of the steering gear, it is provided that the inner ring 17 of the pivot ring 16 and the outer bearing ring 12 of the rotary bearing 9 are disposed so as to be braced between the tension ring 18 and the axial detent 19 which is configured by the bearing sleeve 15.

To this end it is provided in the context of the production of the fixed bearing 6 provided as a contiguous unit for integration in the steering gear that first the rotary bearing 9, subsequently the inner ring 17 of the pivot ring 16, and finally the tension ring 18 are positioned within the bearing sleeve 15 and a pretensioning force F_{V} that acts in the direction of the axial detent 19 is thereafter applied (in an ideally fully circumferential manner) to the tension ring 18 (cf. FIG. 3), said pretensioning force F_{V} leading to the bracing of the elements received within the bearing sleeve 15, wherein said pretensioning force F_{V} exerted on the tension ring 18 is supported in that the bearing sleeve 15 is supported on a counter bearing (not illustrated) (cf. reaction force F_{R} in FIG. 3). To this end, the bearing sleeve 15 externally configures one or a plurality of, respectively, supporting protrusions 26 which (collectively) extend across the largest part of the circumference of the bearing sleeve 15 and which are disposed on that axial end of the bearing sleeve 15 on which the tension ring 18 within the bearing sleeve 15 is also positioned. Like the axial detent 19 of the bearing sleeve 15, the supporting protrusions 26 can also have been configured by forming an axial end portion of the bearing sleeve 15.

Even while the pretensioning force F_{V} is being actively applied to the tension ring 18, the tension ring 18 is permanently connected to the bearing sleeve 15, for example by welding, in particular by means of laser welding. The bracing of the inner ring 17 of the pivot ring 16 and of the outer bearing ring 12 of the rotary bearing 9 between the tension ring 18 and the axial detent 19 of the bearing sleeve 15 is permanently maintained on account thereof.

On account of applying the pretensioning force F_{V} to the tension ring 18, on account of which the latter by way of a correspondingly high force is pushed against the inner ring 17 of the pivot ring 16 and the latter in turn against the outer bearing ring 12 of the rotary bearing 9, said outer bearing ring 12 in turn being supported on the axial detent 19 of the bearing sleeve 15, (in particular) the axial detent 19 of the bearing sleeve 15 is elastically deformed to a relevant degree, on account of which it is ensured that a play-free disposal of the inner ring 17 of the pivot ring 16 and of the outer bearing ring 12 of the rotary bearing 9 between the tension ring 18 and the axial detent 19 is provided even toward the end of an envisaged service life of the steering gear, since a wear-related readjustment of the inner ring 17 of the pivot ring 16 as well as of the outer bearing ring 12 of the ball bearing 9 takes place on account of the restoring effect of the elastically deformed axial detent 19 of the bearing sleeve 15.

### LIST OF REFERENCE SIGNS

1 Housing
2 Gear wheel
3 Helical pinion
4 (Helical) pinion shaft
5 Output shaft
6 Fixed bearing
7 Pivot axis
8 Floating bearing
9 Rotary bearing of the fixed bearing
10 Rotary bearing of the floating bearing
11 Inner bearing ring of a rotary bearing
12 Outer bearing ring of a rotary bearing
13 Bearing device of the fixed bearing
14 Bearing device of the floating bearing
15 Bearing sleeve
16 Pivot ring
17 Inner ring of the pivot ring
18 Tension ring
19 Axial detent of the bearing sleeve
20 Outer ring of the pivot ring
21 Torsion web
22 Coupling piece
23 Screw
24 Screw ring
25 Longitudinal axis of the helical pinion shaft
26 Supporting protrusion
27 External toothing of the helical pinion shaft

1. A fixed bearing for a steering gear, having comprising:
a rotary bearing that includes an inner bearing ring configured to receive a pinion shaft of the steering gear and an outer bearing ring configured to be received in a bearing sleeve; and
a pivot ring having an outer ring and an inner ring, the outer and inner rings pivotably connected by at least one torsion webs,
wherein the inner ring is connected to the bearing sleeve and the outer ring is configured to mount the fixed bearing in a housing of the steering gear, and
wherein the inner ring and the outer bearing ring of the rotary bearing are disposed so as to be braced between an axial detent of the bearing sleeve and a tension ring.

2. The fixed bearing as claimed in claim 1, wherein the axial detent is defined by an end portion of the bearing sleeve, the end portion configured by forming.

3. The fixed bearing as claimed in claim 1, wherein only the inner ring and the outer bearing ring of the rotary bearing are disposed between the axial detent of the bearing sleeve and the tension ring.

4. The fixed bearing as claimed in claim 1, wherein a pretensioning force causing the bracing is at least 8 kN.

5. The fixed bearing as claimed in claim 1, wherein the tension ring is disposed within the bearing sleeve.

6. The fixed bearing as claimed in claim 1, wherein the bearing sleeve externally defines a supporting protrusion.

7. The fixed bearing as claimed in claim 1, wherein the tension ring is welded to the bearing sleeve.

8. A method for producing a fixed bearing that includes a rotary bearing and a pivot ring, the rotary bearing including an inner bearing ring configured to receive a pinion shaft of a steering gear and an outer bearing ring configured to be received in a bearing sleeve, the pivot ring having an outer ring and an inner ring that are pivotably connected by at least one torsion web, the inner ring connected to the bearing sleeve and the outer ring configured to mount the fixed bearing in a housing of the steering gear, the method comprising:
positioning the rotary bearing and the inner ring of the pivot ring within the bearing sleeve between an axial detent of the bearing sleeve and a tension ring; and
generating a defined pretensioning force configured to brace the inner ring of the pivot ring and the outer bearing ring of the rotary bearing between the axial detent of the bearing sleeve and the tension ring.

9. A steering gear for a steering system of a motor vehicle, having comprising:
a gear wheel;
a pinion shaft that includes a helical pinion configured to mesh with the gear wheel; and
a fixed bearing including:
a rotary bearing with an inner bearing ring configured to receive a pinion shaft of the steering gear and an outer bearing ring configured to be received in a bearing sleeve, and
a pivot ring having an outer ring and an inner ring that are pivotably connected by at least one torsion web, the inner ring connected to the bearing sleeve, the inner ring and the outer bearing ring of the rotary bearing disposed so as to be braced between an axial detent of the bearing sleeve and a tension ring,
wherein the pinion shaft on one side of the helical pinion is mounted in the fixed bearing, and
wherein the outer ring of the pivot ring of the fixed bearing is mounted directly or indirectly in a housing of the steering gear.

10. The steering gear as claimed in claim 9, wherein the pinion shaft is configured to be connected in a rotatably driving manner to a steering motor of a steering system.
